(19) United States
(12) Patent Application Publication
(10) Pub. No.: US 2012/0260753 A1
(43) Pub. Date: Oct. 18, 2012

(54) Mechanical advantage apparatus

(76) Inventor: Jerry Disimone, Torrance, CA (US)

(21) Appl. No.: 13/066,469

(22) Filed: Apr. 16, 2011

(51) Int. Cl. F16H 33/08

(52) U.S. Cl. 74/64

(57) ABSTRACT

A Mechanical Advantage Apparatus includes a Cantilever Arm Assembly, a Cantilever Hub Assembly, and a Spoke Assembly. The Cantilever Arm Assembly is rotatably mounted to the Spoke Assembly. In some embodiments, the Mechanical Advantage Apparatus may further include a platform, and a set of supporting braces.

### FIELD OF THE INVENTION

The present invention is in the area of mechanical devices incorporating rotational motion.

### BACKGROUND OF THE INVENTION

When working with mechanical devices or mechanisms, the ratio of the output force produced by a device to the input force applied to it becomes very important. This ratio is called the mechanical advantage. Everyday routines such as opening doors, or lifting a book with your arm, or prying a shoe off your foot are actions with a mechanical advantage. In practically every aspect of life, work is regularly carried out on a daily basis with a mechanical advantage.

Simple machines such as Class 1, Class 2, and Class 3 levers utilize a mechanical advantage to perform work faster and more efficiently. The leverage from these machines is what makes them practical for everyday use and allows us to perform more efficient work in shorter time. It is found in ordinary devices such as tweezers, scissors, paper clips, doors, brooms, nut crackers, hammers, wheelbarrows, crowbars, etc. The list of simple machines with a mechanical advantage is so numerous, it could go on and on. Pulleys and wheels are other types of simple machines that utilize a mechanical advantage in which there is an equilibrium of torques.

However, the common denominator with all of these simple machines, regardless of which class they belong, is that they all have a limited range of motion with their respective mechanical advantage due to the location of the fulcrum, load and effort points. This can best be shown by a simple graph of the distance where the effort is applied to the distance where the load is moved. In all simple machines as described above, a line with a slope would start and stop somewhere on the graph.

Conversely, if a mechanical advantage was incorporated on a rotating shaft, not only would the range of motion for the mechanical advantage increase, it would also have constant leverage throughout the rotation thereby generating a straight horizontal line on a graph. So the mechanical advantage would never decrease. It would be a steady state like d.c. current. New machinery or equipment and devices not yet conceived could take advantage of such leverage for more efficient operation.

Moreover, existing machinery, tools, equipment etc. could be retrofitted to take advantage of such leverage for more efficient operation. Machinery and devices of all types with rotating shafts become more efficient with a mechanical advantage. The uses for such improved efficiency on rotating shafts could be for, but not limited to, gears, wheels, tools, clocks, toys, bicycles, automobiles, RV's, floating crafts, submersibles, boats, ships, submarines, trains, motorcycles, motors, engines, turbines, aircraft systems and all systems that use rotary type devices.

Therefore, what is clearly needed today is an apparatus which incorporates a mechanical advantage on rotating shafts.

### SUMMARY OF THE INVENTION

It is an object of the present invention to provide a novel apparatus that results in more efficient operation for rotary equipment or devices. The present invention is specifically designed such that a mechanical advantage is sustained during rotary motion.

### BRIEF DESCRIPTION OF THE DRAWING FIGURES

FIG. 1 is a perspective view of a preferred embodiment of the present invention.

FIG. 2 is a plan view of a preferred embodiment of the present invention.

FIG. 3 is a perspective view of a preferred embodiment of the present invention.

FIG. 4 is a front elevation view of a preferred embodiment of the present invention.

FIG. 5 is a perspective view of a preferred embodiment of the present invention.

FIG. 6 is a plan view of a Spoke Assembly to be used with a preferred embodiment of the present invention.

FIG. 7 is a plan view of a Spoke Assembly to be used with a preferred embodiment of the present invention.

FIG. 8 is a plan view of a Spoke Assembly to be used with a preferred embodiment of the present invention.

FIG. 9 is a perspective view of a Cantilever Hub Assembly to be used with a preferred embodiment of the present invention.

FIG. 10 is a front elevation view of a Miter Gear to be used with a preferred embodiment of the present invention.

FIG. 11 is a front elevation view of an External Cantilever Hub Assembly with gears on the outside of the spoke assembly to be used with a preferred embodiment of the present invention.

FIG. 12 is a plan view of a Cantilever Hub Assembly to be used with a preferred embodiment of the present invention.

FIG. 13 is a perspective view of a Single Spoke Assembly to be used with a preferred embodiment of the present invention.

FIG. 14 is a front elevation view of a preferred embodiment of the present invention.

### DESCRIPTION OF PREFERRED EMBODIMENTS

According to a preferred embodiment of the present invention, a unique apparatus is provided to improve output efficiency through a unique design, which incorporates principles of levers through a rotary condition. When a mass of some value is positioned at a pre-determined distance from an axis, the resulting action is a sustained mechanical advantage. The present invention is described in enabling detail below.

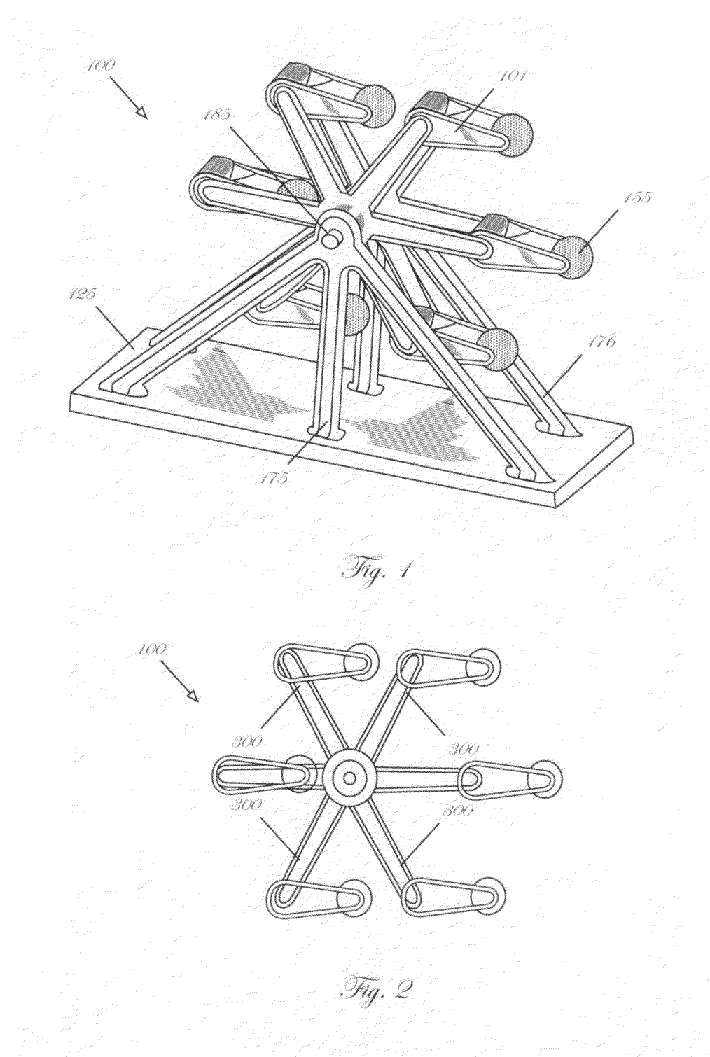

FIG. 1-3 illustrate a preferred embodiment of the present invention. A Mechanical Advantage Apparatus 100 includes a Cantilever Arm Assembly 101, a Cantilever Hub Assembly 102, and a Spoke Assembly 103. The Cantilever Arm Assembly is rotatably mounted to the Spoke Assembly.

The Spoke Assembly 103 is rotatably mounted to the Main Hub Assembly 185. The Spoke Assembly is comprised of at least two supporting spokes 300 upon which the Cantilever Arm Assembly and the Cantilever Hub Assembly rotate. It should be noted here that in some preferred embodiments, only one spoke is required. A single spoke embodiment is illustrated in FIG. 13.

FIG. 1 also illustrates that in some preferred embodiments the Main Hub Assembly may comprise of Hub Support Braces 175, 176. The Hub Support Braces 175, 176 are affixed with the Platform Stabilizer 125. The Hub Support Braces 175, 176 are disposed outside of the Spoke Assembly and sandwich the Spoke Assembly. The Hub Support Braces 175, 176 include a Spoke Orifice sized to accept the Primary Axle 115.

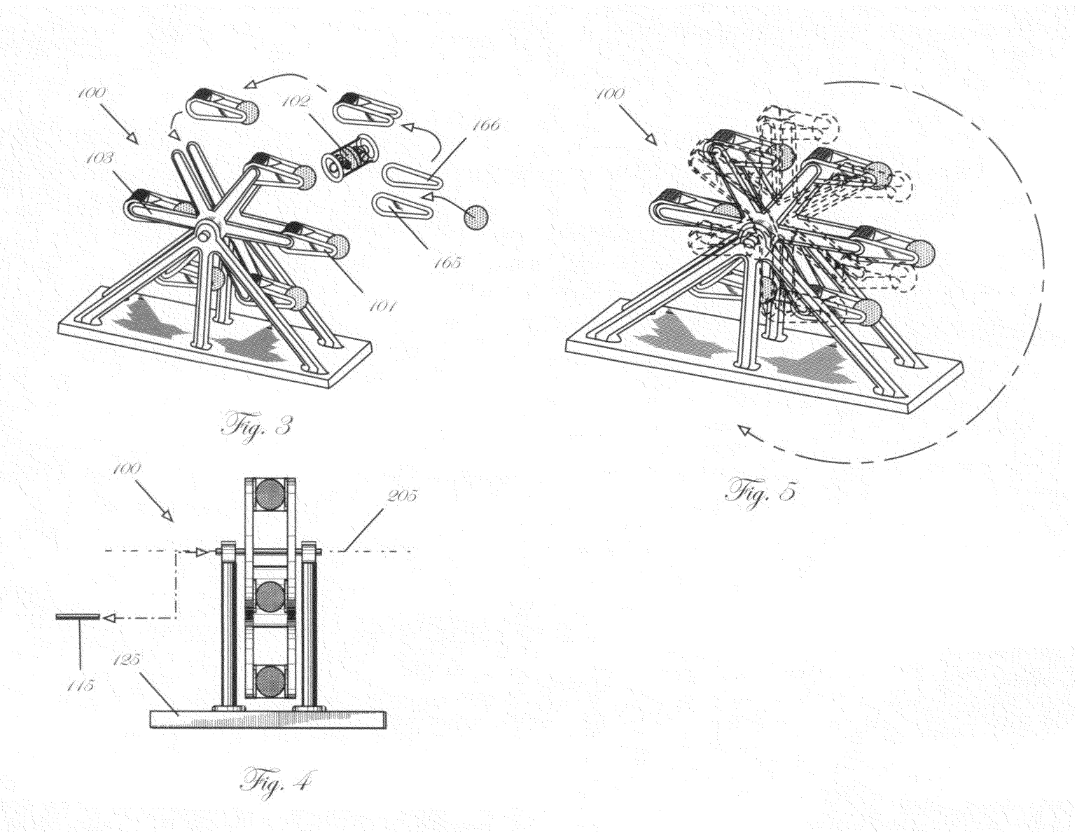

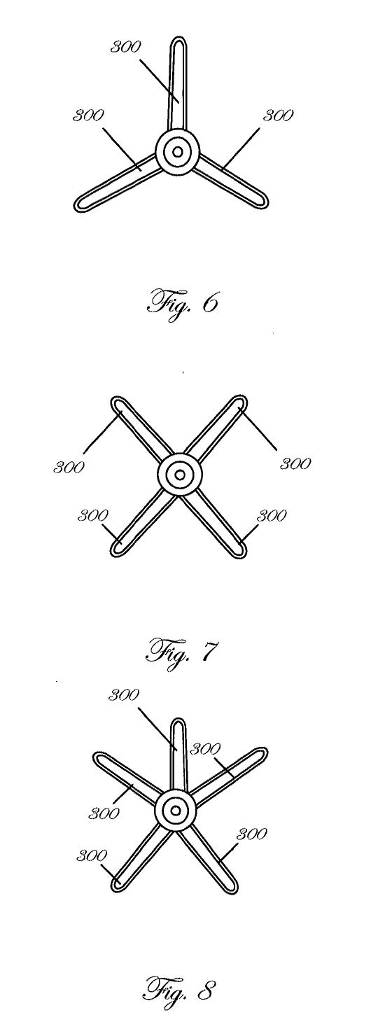

FIG. 4 illustrates that in some preferred embodiments, a Primary Axle 115 is disposed longitudinally through the orifices of the spoke assembly and the support braces 175, 176. The Spoke Assembly rotates about the Main Axis 205. The Cantilever Arm Assembly is mounted such that it remains substantially horizontal with the Cantilever Hub Assembly as it is rotated around a Main Axis 205. This horizontal position is made possible through the use of, but not limited to, gears, belts, chains, magnets, or other means. Each Cantilever Arm Assembly is spaced substantially equidistantly from each other respective to their disposition upon each spoke of the Mechanical Advantage Apparatus.

In operation, the Cantilever Arm Assembly is positioned such that the resulting distance between the Main Axis and the Weight 155 produces a rotational mechanical advantage. The mechanical advantage can be changed by changing the length of the Cantilever Arm Assembly.

FIG. 9 illustrates a Cantilever Hub Assembly 102 to be incorporated in some preferred embodiments of the present invention. The Cantilever Hub Assembly 102 could include a Miter Gear Assembly 505. A Miter Gear Assembly 505 would enable a Weight 155 to remain in a horizontal position respective to its position with the Miter Gear Assembly 505 and Platform 125.

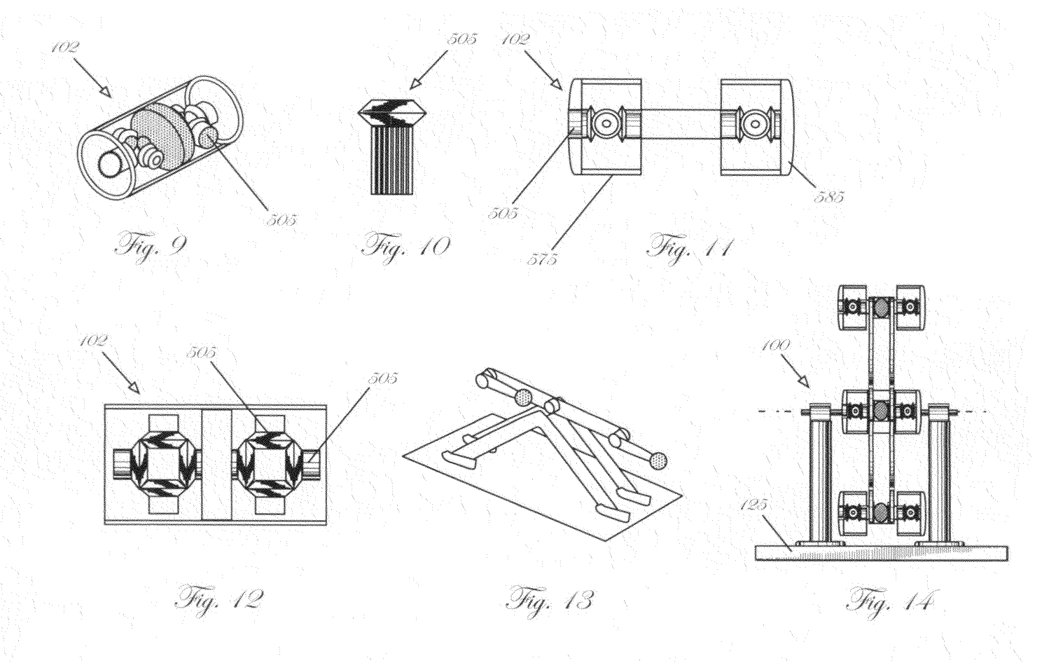

FIGS. 11 and 14 illustrate that in some preferred embodiments, an External Cantilever Hub Assembly is used wherein the gears are disposed outside of the spoke assembly. This arrangement may be necessary as loads increase, and the resulting structure may need a more robust foundation.

FIGS. 11-12 illustrate that in some preferred embodiments, the Cantilever Hub Assembly further includes a Housing 575, and a cap 585. The cap helps retain oil within the housing.

FIG. 3 illustrates that the Cantilever Arm Assembly may include a First Sandwich Member 165 and a Second Sandwich member 166. Each Sandwich Member engages opposite sides of the Weight 155. It should be noted that in some preferred embodiments, the Cantilever Arm Assembly may consist of one, two or more elongated members where an additional Weight may or may not be affixed at some point.

The Spoke Orifice is simply a bored hole through the Hub Support Braces 175, 176. It should be noted that in some preferred embodiments, any type of support such as wall mounting or some other method could work for elevating the apparatus sufficient for clearance for rotation.

FIGS. 8-10 illustrate that the Spoke Assembly 103 may come in different or other wheel type rims. As such, the present invention should not be construed as limiting in the number of Spokes 300 and the attendant Cantilever Arm Assemblies. Each Spoke is disposed equidistantly from each other.

It should also be noted here that in some preferred embodiments, a Spoke Assembly may comprised of at least two cooperating spokes which may or may not sandwich the Cantilever Arm Assembly. However, in alternative preferred embodiments, the Spoke Assembly may comprise a Single Spoke Assembly which is rotatably affixed with the Cantilever Arm Assembly or a Spoke Assembly 103 or any number of spoke assemblies.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Mechanical Advantage Apparatus comprising:
a Cantilever Arm Assembly, a Cantilever Hub Assembly, and a Spoke Assembly;
the Cantilever Arm Assembly is affixed with the Cantilever Hub Assembly, and both the Cantilever Hub Assembly and the Cantilever Arm Assembly are affixed to the Spoke Assembly;
the Cantilever Arm Assembly is disposed such that it remains substantially parallel with a bottom surface.

2. The Mechanical Advantage Apparatus of claim 1 further comprising a platform.

3. The Mechanical Advantage Apparatus of claim 2 further comprising at least one support brace; the support brace is affixed with the spoke assembly.

4. The Mechanical Advantage Apparatus of claim 1 further comprising a Primary Axle.

5. The Mechanical Advantage Apparatus of claim 1 further comprising a miter gear assembly; the miter gear assembly is housed within the Cantilever Hub Assembly.

6. The Mechanical Advantage Apparatus of claim 2 wherein the Spoke Assembly comprises three sets of spokes.

7. The Mechanical Advantage Apparatus of claim 2 wherein the Spoke Assembly comprises four sets of spokes.

8. The Mechanical Advantage Apparatus of claim 2 wherein the Spoke Assembly comprises five sets of spokes.

9. The Mechanical Advantage Apparatus of claim 2 wherein the Spoke Assembly comprises six sets of spokes.

10. The Mechanical Advantage Apparatus of claim 2 wherein the Spoke Assembly comprises at least two sets of spokes.

11. The Mechanical Advantage Apparatus of claim 1 wherein the gears of the Cantilever Hub Assembly are disposed between the spokes of the spoke assembly.

12. The Mechanical Advantage Apparatus of claim 1 wherein the gears of the Cantilever Hub Assembly are disposed outside of the spokes of the spoke assembly.
